(19) United States
(12) Patent Application Publication
(10) Pub. No.: US 2007/0276658 A1
(43) Pub. Date: Nov. 29, 2007

(54) Apparatus and Method for Detecting Speech Using Acoustic Signals Outside the Audible Frequency Range

(76) Inventor: Barry Grayson Douglass, Austin, TX (US)

Correspondence Address: BARRY GRAYSON DOUGLASS, 2117 Diamond Creek Circle Apartment M, Charlotte, NC, 28273, US

(21) Appl. No.: 11/308,895

(22) Filed: May 23, 2006

(51) Int. Cl. G10L 19/14; G10L 21/00

(52) U.S. Cl. 704/205

(57) ABSTRACT

The present invention employs sound generators, also known as acoustic transducers, which produce ultrasound or infrasound outside the normal human hearing range, placed in proximity to the vocal tract of the person whose speech is being detected, such as in front of the mouth. One or more microphones sensitive to these ultrasound or infrasound signals are also placed near the speaker's vocal tract, to pick up the return signals from the speaker, which are modified by passage through and around the vocal tract as the person speaks. This invention overcomes the limitations of detecting speech by the traditional method of capturing normal voice acoustic signals. The added information from the infrasound or ultrasound signals creates a unique acoustic signature for each action of the vocal tract during speech, which can be used to improve the reliability of computer speech recognition and the quality of transmitted voice.

### BACKGROUND OF THE INVENTION

The invention relates generally to the detection of human spoken speech by a machine, and more particularly to the identification of specific words as they are spoken by a user of the invention.

### DESCRIPTION OF THE RELATED ART

Speech detection is the process where human speech is captured with a microphone linked to a machine and processed to distinguish spoken words, either for computer speech recognition, or for the purpose of improving the quality of the sound for retransmission to a human listener, such as by radio. In computer speech recognition the spoken sounds are processed by the computer in order to create as nearly as possible an error-free transcription of the spoken words. This has practical applications in using voice commands to operate machines, as well as to use computers to perform dictation.

When voice is being captured for retransmission to a listener it is sometimes the case that the speaker's acoustic environment is noisy, or the speaker must speak in a low voice volume in order to avoid being overheard. In such situations a normal microphone may not be able to capture the speaker's voice with sufficient fidelity to permit intelligible reproduction when it is transmitted to a listener. In order to enhance the quality of the transmitted sound, the acoustic information captured by the microphone is processed through filters and amplifiers.

The nature of the processing that is done on the acoustic voice signal, whether for computer speech recognition or voice signal enhancement before transmission to a listener, can be very complex, but the key characteristic of this processing in the prior art as it relates to the invention is that all the processing is done to the normal voice signal after the signal is captured by a microphone. This imposes a limitation on the quality of the speech detection. In computer speech recognition the spoken sounds are first processed to create a set of symbolic representations of each sound, called phonemes, which are then compared to a database of phonemes corresponding to each word. If errors occur in identifying the phonemes from the sounds, then the software must use information about the context of speech to try and eliminate ambiguity in the possible choices of words. Even with the best existing art, computer speech recognition is still considered marginally adequate at best, since the transcription error rate is significant. Current methods of voice signal enhancement are effective in improving the quality of transmitted voice, but some voice signals cannot be adequately detected even by these methods, either because the noise level is too high or the voice signal volume is too low.

### SUMMARY OF THE INVENTION

The speech detection apparatus of the present invention employs sound generators such as loudspeakers, also known as acoustic transducers, which produce sounds outside the human hearing frequency range, as ultrasound or infrasound. These are placed in proximity to the speaker's vocal tract, such as in front of the mouth. One or more microphones sensitive to these ultrasound or infrasound signals are also placed near the speaker's vocal tract, so that they pick up the return signals from the speaker, which are modified by passage through and around the vocal tract as the speaker utters words. This is similar to the prior art process of synthesized voice being modified by passage through the vocal tract of persons who have lost their vocal chords, for whom a prosthetic device is used to generate a synthetic audible voice sound in the mouth or at the throat of the user. The present invention overcomes the limitations of speech detection by the traditional method of capturing normal voice acoustic signals. The added information from the infrasound and ultrasound signals creates a unique acoustic signature for each action of the vocal tract during speech, which can be used to improve the reliability of computer speech recognition and the quality of transmitted voice. Since in the prior art ultrasound signals have been commonly used in medicine to create detailed images of soft tissues such as the human vocal tract, they are demonstrably well suited to detecting actions of the vocal tract during speech. The application of ultrasound in the present invention is less demanding than imaging, since it is sufficient to create unique acoustic signatures associated with specific actions of the vocal tract. Because the generated acoustic signals are inaudible they can be used in environments where the speaker does not want to be overheard and therefore must speak quietly.

The speech detection apparatus of the present invention comprises means for generating an acoustic signal outside the audible frequency range at the vocal tract of the person whose speech is being detected, such as an ultrasound and/or infrasound acoustic signal, means for capturing the acoustic signal once it has interacted with the vocal tract of the person whose speech is being detected, and means for detecting changes to the captured acoustic signal due to speech. The means for generating the acoustic signal may comprise one or more acoustic transducers, and the means for capturing the acoustic signal may comprise one or more microphones sensitive to the frequency ranges of the acoustic signal.

One variation of the invention comprises an apparatus for detecting speech, comprising means for determining the phonemes being spoken by the person whose speech is being detected, by comparing the pattern of the captured acoustic signal to a previously recorded database of speech patterns and their corresponding phonemes. Another variation of the invention comprises an apparatus for detecting speech, comprising means for remodulating the captured acoustic signal to frequencies within the audible range while preserving the speech signal modulation pattern. Such means for remodulating the captured acoustic signal may comprise electronic circuits employing the same means of remodulating signals as have been commonly used in radio broadcasting in the prior art.

Another variation of the invention is a method for detecting speech comprising generating an acoustic signal outside the audible frequency range at the vocal tract of the person whose speech is being detected, and capturing the acoustic signal after it has interacted with the vocal tract of the person whose speech is being detected, wherein the acoustic signal captured after it has interacted with the vocal tract is then processed to detect changes to the acoustic signal due to its interaction with the vocal tract, these changes being advantageously substantially distinct for each action of the vocal tract during speech.

In another variation of the method the processing to detect changes to the acoustic signal due to its interaction with the vocal tract comprises determining the phonemes being spoken by the person whose speech is being detected, by comparing the pattern of the captured acoustic signal to a recorded database of speech patterns and their corresponding phonemes. The methods used in performing this processing are equivalent to the methods applied to normal voice signals for phoneme detection in the prior art for computer speech recognition. In another variation of the method the processing to detect changes to the acoustic signal due to its interaction with the vocal tract comprises remodulating the captured acoustic signal to frequencies within the audible range while preserving the speech signal modulation pattern, thus creating a synthesized facsimile of normal speech.

In another variation of the method generating an acoustic signal outside the audible frequency range at the vocal tract of the person whose speech is being detected comprises placing one or more acoustic transducers advantageously arranged at different positions near and around the vocal tract. In yet another variation of the method capturing the acoustic signal after it has interacted with the vocal tract of the person whose speech is being detected comprises placing one or more microphones advantageously arranged at different positions near and around the vocal tract. In yet another variation of the method the acoustic signal outside the audible frequency range is generated with a frequency spectrum which varies at intervals. In another variation of the method the acoustic signal is generated at varying strength at intervals. In another variation of the method the processing to detect changes to the acoustic signal due to its interaction with the vocal tract comprises detecting time delay in the acoustic signal resulting from interaction with the vocal tract during speech.

In yet another variation of the method the generated acoustic signal outside the audible frequency range comprises ultrasound. In yet another variation of the method the generated acoustic signal outside the audible frequency range comprises infrasound. In yet another variation of the method the generated acoustic signal outside the audible frequency range comprises a component of a sampled normal human voice, which is remodulated to a frequency range outside the audible frequency range.

In another variation the method comprises capturing the normal voice sound of the person speaking, wherein the processing to detect changes to the acoustic signal due to its interaction with the vocal tract is combined with speech detection of the normal voice sound.

### BRIEF DESCRIPTION OF THE DRAWINGS

In the drawings, wherein like reference characters indicate like parts,

FIG. 1 shows the basic components and their interconnections for the present invention;

FIG. 2 is a representation of typical placement of acoustic transducers and microphones around the vocal tract of the person speaking for the present invention.

### DESCRIPTION OF THE PREFERRED EMBODIMENT

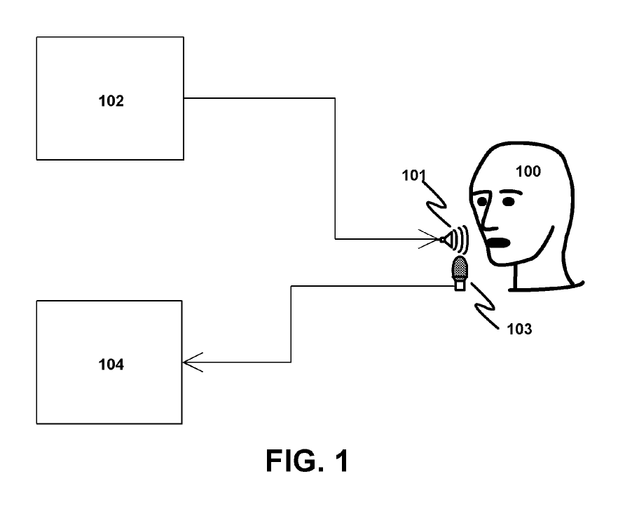

In one variation of the embodiment, the present invention is an apparatus and method for detecting speech comprising means for generating an acoustic signal outside the audible frequency range, whether ultrasound or infrasound, in any combination of frequencies, applied continuously or varying in strength and/or frequency over time, and means for capturing the acoustic signal after it has interacted with the vocal tract of the person whose speech is being detected, wherein the acoustic signal captured after it has interacted with the vocal tract is then processed to detect changes to the acoustic signal due to its interaction with the vocal tract, such changes being advantageously substantially distinct for each action of the vocal tract during speech. The means for generating the acoustic signal may be one or more acoustic transducers placed in proximity to the vocal tract of the person whose speech is being detected. The means for capturing the acoustic signal may be one or more microphones placed in proximity to the vocal tract. FIG. 1 shows the basic components of the invention. The person whose speech is being detected 100 has one or more acoustic transducers 101 placed in proximity to the vocal tract, such as in front of the mouth. The ultrasound or infrasound signal is generated advantageously as an electronic signal in signal generator 102 and then fed to one or more acoustic transducers 101. Once this acoustic signal has interacted with the person's vocal tract it is captured by one or more microphones 103 and from these fed advantageously as an electronic signal, to signal processor 104. The processing of the captured acoustic signal takes place in signal processor 104.

Another variation of the embodiment is an apparatus and method to process the captured acoustic signal to translate the frequency spectrum from the ultrasound or infrasound range to within the audible range, while preserving the modulation of the acoustic signal resulting from interaction with the vocal tract. This processing takes place in signal processor 104 and results in a synthesized facsimile of normal voice, incorporating the modulation due to speech. One application of the invention is to transmit the synthesized voice signal to a listener for communication. Since the original acoustic signal used to capture the voice modulation is inaudible and doesn't require the person speaking to employ the vocal chords, the speaker can whisper or simply “mouth” the words silently in order to communicate. This permits verbal communication by electronic means without the speaker being overheard, or more generally if for any reason the speaker does not wish to or cannot make audible voice sounds.

Another variation of the embodiment is an apparatus and method to compare the captured acoustic signal to a previously recorded database of similarly produced acoustic signals with a record of their corresponding phonemes, where this comparison is used to determine which phoneme corresponds to the specific acoustic signature. This comparison takes place in signal processor 104. In this way a phoneme transcription is produced, which can be used in a computer speech recognition system. Because multiple signal sources, multiple microphones, multiple frequencies, and precise signal timing can all be used to develop a unique acoustic signature for each position and movement of the vocal tract, a potentially much more precise acoustic signature can be obtained than with a passive normal voice microphone alone.

In another variation of the method for detecting speech the generated acoustic signal outside the audible frequency range comprises a suitable component of a sampled normal human voice, which is remodulated to a frequency range outside the audible frequency range. This results in an ultrasound or infrasound signal which contains the same variety of acoustic frequencies as normal voice, translated outside the audible frequency range, thus most closely approximating the normal speech process.

Another variation of the embodiment is an apparatus and method to process the captured acoustic signal in combination with the separately captured normal voice sound signal of the person speaking so as to increase the accuracy of computer speech recognition, or so as to enhance the quality of the transmitted normal voice sound. This processing takes place in signal processor 104. This is especially useful in noisy environments since the combination of the generated acoustic signal and the microphones can be concentrated in both frequency and strength to overcome background noise.

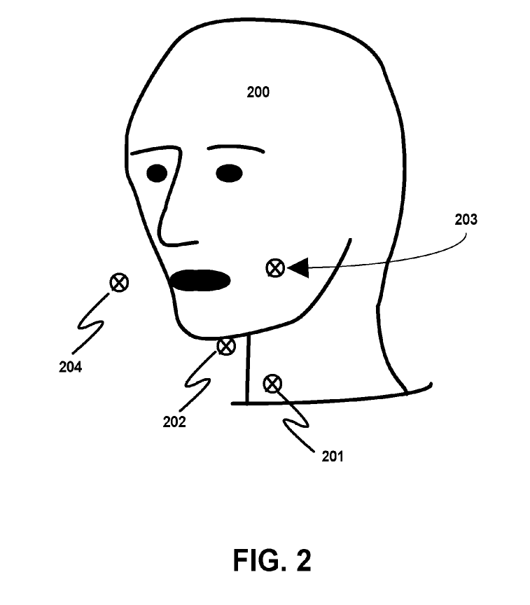

FIG. 2 shows possible placement positions for both the acoustic transducers and separately for the microphones, where these can be independently placed in any combination at any or all of these positions. For the person whose speech is being detected 200 these include (but are not limited to) at the throat 201, under the chin 202, against the cheek 203, in front of the mouth 204, or inside the mouth (not shown).

These and other variations and modifications of the embodiments disclosed herein may be made without departing from the scope and spirit of the invention the scope as set forth in the following claims.

What is claimed is:

1. An apparatus for detecting speech comprising:
means for generating an acoustic signal outside the audible frequency range at the vocal tract of the person whose speech is being detected;
means for capturing the acoustic signal after it has interacted with the vocal tract of the person whose speech is being detected; and
means for detecting changes to the captured acoustic signal caused by speech.

2. An apparatus for detecting speech as in claim 1, wherein the means for generating an acoustic signal outside the audible frequency range comprises means for generating ultrasound.

3. An apparatus for detecting speech as in claim 1, wherein the means for generating an acoustic signal outside the audible frequency range comprises means for generating infrasound.

4. An apparatus for detecting speech as in claim 1, wherein the means for detecting changes to the captured acoustic signal comprises means for determining the phonemes being spoken by the person whose speech is being detected, by comparing the pattern of the captured acoustic signal to a database of speech patterns and their corresponding phonemes.

5. An apparatus for detecting speech as in claim 1, wherein the means for detecting changes to the captured acoustic signal comprises means for remodulating the captured acoustic signal to within the audible frequency range while preserving the speech signal modulation pattern.

6. An apparatus for detecting speech as in claim 1, wherein the means for generating an acoustic signal outside the audible frequency range comprises an acoustic transducer.

7. An apparatus for detecting speech as in claim 1, wherein the means for capturing the acoustic signal comprises a microphone.

8. A method for detecting speech comprising:
generating an acoustic signal outside the audible frequency range at the vocal tract of the person whose speech is being detected;
capturing the acoustic signal after it has interacted with the vocal tract of the person whose speech is being detected; and
processing the captured acoustic signal to detect changes to the signal caused by speech.

9. A method for detecting speech as in claim 8 wherein processing the captured acoustic signal to detect changes to the signal caused by speech comprises determining the phonemes being spoken by the person whose speech is being detected, by comparing the pattern of the captured acoustic signal to a database of speech patterns and their corresponding phonemes.

10. A method for detecting speech as in claim 8 wherein processing the captured acoustic signal to detect changes to the signal caused by speech comprises remodulating the captured acoustic signal to within the audible frequency range while preserving the speech signal modulation pattern.

11. A method for detecting speech as in claim 8 wherein generating an acoustic signal outside the audible frequency range comprises placing an acoustic transducer near the vocal tract.

12. A method for detecting speech as in claim 8 wherein capturing the acoustic signal after it has interacted with the vocal tract of the person whose speech is being detected comprises placing a microphone near the vocal tract.

13. A method for detecting speech as in claim 12 comprising placing a plurality of microphones advantageously arranged at positions around the vocal tract.

14. A method for detecting speech as in claim 11 comprising placing a plurality of acoustic transducers advantageously arranged at positions around the vocal tract.

15. A method for detecting speech as in claim 8 wherein generating an acoustic signal outside the audible frequency range comprises generating an acoustic signal outside the audible frequency range with a frequency spectrum which varies at intervals.

16. A method for detecting speech as in claim 8 wherein processing the captured acoustic signal to detect changes to the signal caused by speech comprises detecting time delay in the captured acoustic signal caused by speech.

17. A method for detecting speech as in claim 8 wherein generating an acoustic signal outside the audible frequency range comprises generating an acoustic signal outside the audible frequency range of varying strength at intervals.

18. A method for detecting speech as in claim 8 wherein generating an acoustic signal outside the audible frequency range comprises generating ultrasound.

19. A method for detecting speech as in claim 8 wherein generating an acoustic signal outside the audible frequency range comprises generating infrasound.

20. A method for detecting speech as in claim 8 wherein generating an acoustic signal outside the audible frequency range comprises generating a component of a sampled normal human voice which is remodulated to a frequency range outside the audible frequency range.
